(19) United States
(12) Patent Application Publication
(10) Pub. No.: US 2013/0219277 A1
(43) Pub. Date: Aug. 22, 2013

(54) Gesture and Voice Controlled Browser

(71) Applicants: Yu Wang, Beijing (CN); Yan Yu, Beijing (CN); Jia Yuan, Wuhan (CN); Yongzhi Yang, Wuhan (CN); Tiefeng Liu, Wuhan (CN)

(72) Inventors: Yu Wang, Beijing (CN); Yan Yu, Beijing (CN); Jia Yuan, Wuhan (CN); Yongzhi Yang, Wuhan (CN); Tiefeng Liu, Wuhan (CN)

(73) Assignee: MoboTap Inc., San Francisco, CA (US)

(21) Appl. No.: 13/401,720

(22) Filed: Feb. 21, 2012

(51) Int. Cl. G06F 3/16

(52) U.S. Cl. 715/728

(57) ABSTRACT

A computer readable storage medium stores instructions defining a mobile device browser. The mobile device browser supports direct command inputs and executable instructions to correlate a proxy command to a selected direct command input. The proxy command is alternately expressed as a gesture and a voice command. The selected direct command input is automatically executed by the mobile device browser.

### FIELD OF THE INVENTION

This invention relates generally to accessing information in communications networks. More particularly, this invention is directed toward a browser controlled by physical gestures and voice commands.

### BACKGROUND OF THE INVENTION

A browser or web browser is a software application for retrieving, presenting, and traversing information resources on a network, such as the World Wide Web. An information resource may be identified by a Uniform Resource Identifier (URI) and may be a web page, image, video or other piece of content. Hyperlinks present in resources allow users to easily navigate their browsers to related resources. Although browsers are primarily intended to access the World Wide Web, they can also be used to access information provided by web servers in private networks or files in file systems.

Operating a browser on a mobile device (e.g., a smart phone, personal digital assistant, tablet and the like) creates challenges since most users find it cumbersome to type commands into a browser on a mobile device. Therefore, it would be desirable to provide improved control mechanisms for browsers, particularly those deployed on mobile devices.

### SUMMARY OF THE INVENTION

A computer readable storage medium stores instructions defining a mobile device browser. The mobile device browser supports direct command inputs and executable instructions to correlate a proxy command to a selected direct command input. The proxy command is alternately expressed as a gesture and a voice command. The selected direct command input is automatically executed by the mobile device browser.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 1A illustrates gesture command processing associated with an embodiment of the invention.

FIG. 2 illustrates gesture commands utilized in accordance with an embodiment of the invention.

FIG. 3 illustrates a gesture entered into a browser configured in accordance with an embodiment of the invention.

FIG. 4 illustrates a graphical user interface that may be used to specify custom gestures in accordance with an embodiment of the invention.

FIG. 5 illustrates voice command configuration operations utilized in accordance with an embodiment of the invention.

FIG. 6 illustrates a voice command graphical user interface that may be used in accordance with an embodiment of the invention.

FIG. 7 illustrates voice command processing operations utilized in accordance with an embodiment of the invention.

FIG. 8 illustrates a voice command graphical user interface that may be used in accordance with an embodiment of the invention.

FIG. 9 illustrates exemplary client-side and server-side processing utilized in accordance with an embodiment of the invention.

FIG. 10 illustrates token processing operations associated with an embodiment of the invention.

FIG. 11 illustrates various voice command operating modes associated with embodiments of the invention.

FIG. 12 illustrates a speed dial for listing frequently accessed web sites, which may be used in accordance with an embodiment of the invention.

FIG. 13 illustrates a graphical user interface to invoke content filtered in accordance with an embodiment of the invention.

FIG. 14 illustrates a graphical user interface with received content filtered in accordance with an embodiment of the invention.

FIG. 15 illustrates a graphical user interface with a side bar for tool resources supplied in accordance with an embodiment of the invention.

FIG. 16 illustrates a graphical user interface with a side bar for bookmarks utilized in accordance with an embodiment of the invention.

FIG. 17 illustrates a graphical user interface with multiple tabs simultaneously supporting multiple browser sessions in accordance with an embodiment of the invention.

FIG. 18 illustrates a unified gesture and voice control graphical user interface associated with an embodiment of the invention.

FIG. 19 illustrates a gesture received in accordance with an embodiment of the invention.

FIG. 20 illustrates a voice command being processed in accordance with an embodiment of the invention.

FIG. 21 illustrates proxy command invocation techniques that may be used in accordance with embodiments of the invention.

FIG. 22 illustrates a proxy command invocation technique that may be used in accordance with an embodiment of the invention.

Like reference numerals refer to corresponding parts throughout the several views of the drawings.

### DETAILED DESCRIPTION OF THE INVENTION

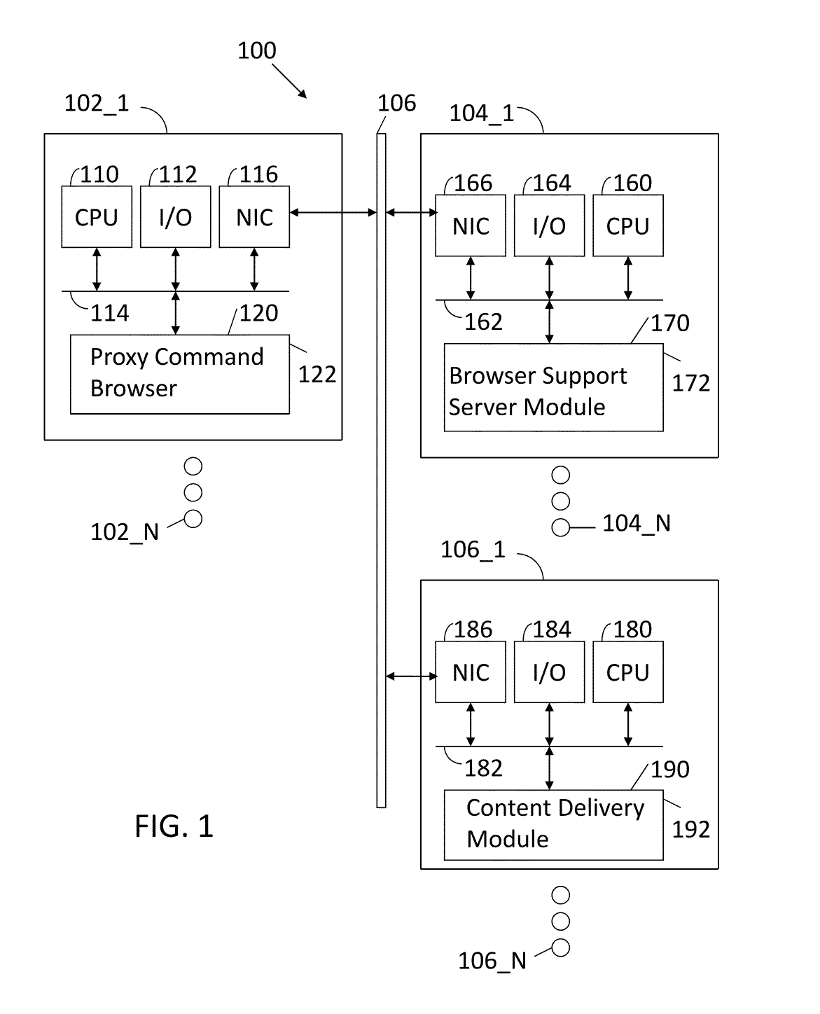

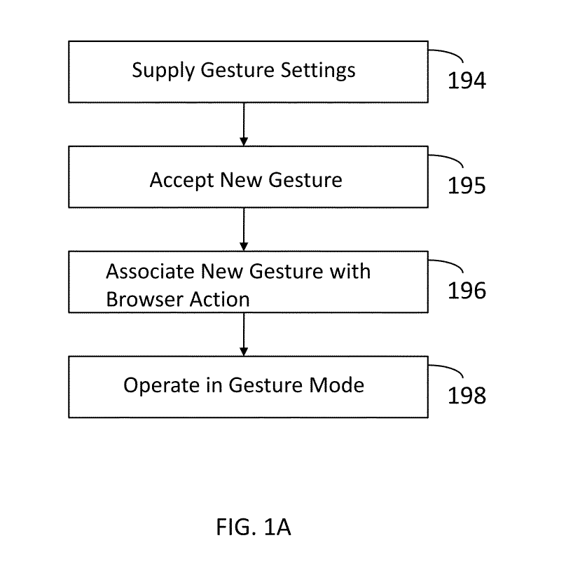

FIG. 1 illustrates a system 100 configured in accordance with an embodiment of the invention. The system 100 includes one or more client devices 102_1 through 102_N. Each client device may be a computer or mobile device with standard components, such as a central processing unit 110 and input/output devices 112 connected via a bus 114. The input/output devices 112 may include a keyboard, microphone, touch display, speaker and the like. A network interface circuit 116 is also connected to the bus 114. The network interface circuit 116 provides an interface to network 106, which may be any wired or wireless network.

A memory 120 is also connected to the bus 114. In one embodiment, the memory 120 stores a proxy command browser 122. The proxy command browser 122 includes executable instructions to define a browser that supports direct command inputs (e.g., typed commands or commands selected from a menu). In addition, the proxy command browser 122 includes executable instructions to correlate a proxy command to a selected direct command input. The proxy command is alternately expressed as a gesture and a voice command. The gesture is a physical action applied to a touch display of the mobile device. A voice command is an uttered command received by a microphone associated with the mobile device. The selected direct command input is automatically executed by the proxy command browser 122.

Thus, the proxy command browser 122 supports direct command inputs and proxy command inputs which may be expressed through a physical gesture or a voice command. Consequently, the proxy command browser 122 provides additional control mechanisms for browsers. These additional control mechanisms are particularly useful when used in connection with mobile devices.

System 100 also includes one or more browser support servers 104_1 through 104_N. Each browser support server 104 includes standard components, such as a central processing unit 160 and input/output devices 164 connected via a bus 162. A network interface circuit 166 is also connected to the bus 162 and provides connectivity to network 106. A memory 170 is also connected to the bus 162. The memory 170 stores a browser supporter server module 172, which includes executable instructions to implement certain operations associated with embodiments of the invention.

The proxy command browser 122 is configured to communicate with the browser support server module 172. For example, the proxy command browser 122 may communicate with the browser support server module 172 to offload or share the processing burden associated with the handling of a proxy command. The proxy command browser 122 may also communicate with the browser support server module 172 to access filtered content, as discussed below. Thus, while the proxy command browser 122 is operative as a standalone application on the client device 102, in many modes of operation it regularly communicates with the browser support server module 172 for augmented functionality.

The system 100 also includes content servers 106_1 through 106_N. Each content server 106 includes standard components, such as a central processing unit 180 and input/output devices 184 connected via a bus 182. A network interface circuit 186 is also connected to the bus 182 to provide connectivity with network 106. A memory 190 is also connected to the bus 182. The memory 190 stores a content delivery module 192, which includes executable instructions to deliver content in response to a request from the proxy command browser 122. The content may be any information resource, such as a web page, image, video, or other piece of content. The content may be delivered directly to the proxy command browser 122. Alternately, the proxy command browser 122 may initiate the content request through the browser support server module 172, in which case, the browser support server module 172 may filter content from the server 106, as discussed below. Thus, the proxy command browser may operate with a content server 106 in a standard manner and in an augmented functionality manner through the browser support server module 172.

FIG. 1A illustrates gesture processing operations associated with an embodiment of the invention. In one embodiment, a set of gestures are supplied to a user 194. A gesture is a movement applied to a display of a computing device.

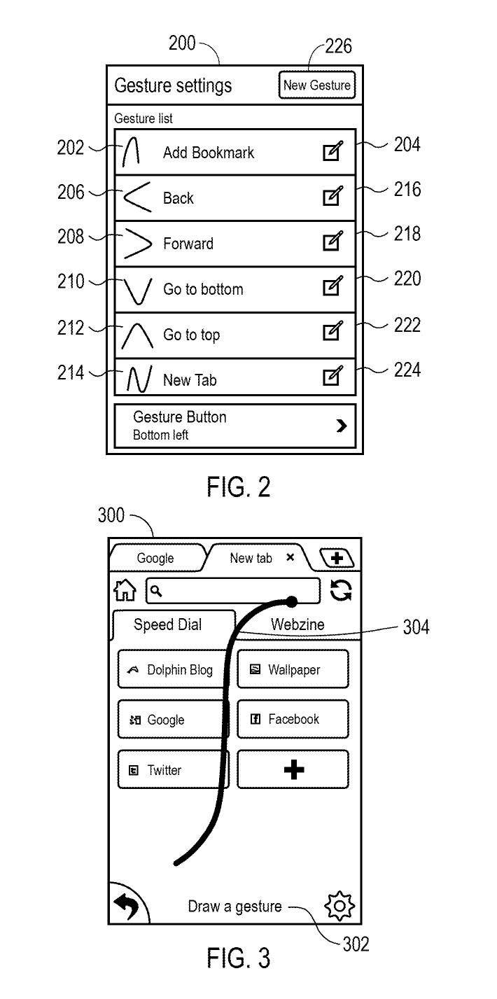

FIG. 2 illustrates a graphical user interface (GUI) 200 associated with the proxy command browser 122 to display gestures and commands associated with the gestures. Gesture 202 applied to a touch display of a client device results in a selected direct command input of “Add Bookmark” 204. Additional gestures 206, 208, 210, 212 and 214 respectively result in selected direct command inputs “Back” 216, “Forward” 218, “Go to bottom” 220, “Go to top” 222 and “New Tab” 224. Thus, GUI 200 provides a set of pre-existing or default gestures that may be used to operate the proxy command browser 122.

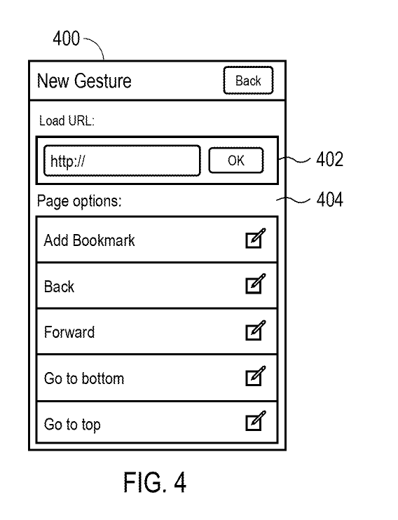

Returning to FIG. 1A, the next processing operation is to accept a new gesture 195. The “New Gesture” icon 226 of FIG. 2 may be selected to define a user-defined gesture. Selection of icon 226 may result in the display of GUI 300 of FIG. 3. Command block 302 invites the user to draw a gesture, which is shown as gesture 304 in FIG. 3. After gesture 304 is entered, GUI 400 of FIG. 4 may be displayed. GUI 400 allows one to specify through block 402 a URL to be associated with the gesture. Alternately, various browser page options 404 may be associated with the user defined gesture. Thus, as shown with block 196 of FIG. 1A, a new gesture is associated with a browser action. The browser may then be operated in gesture mode 198.

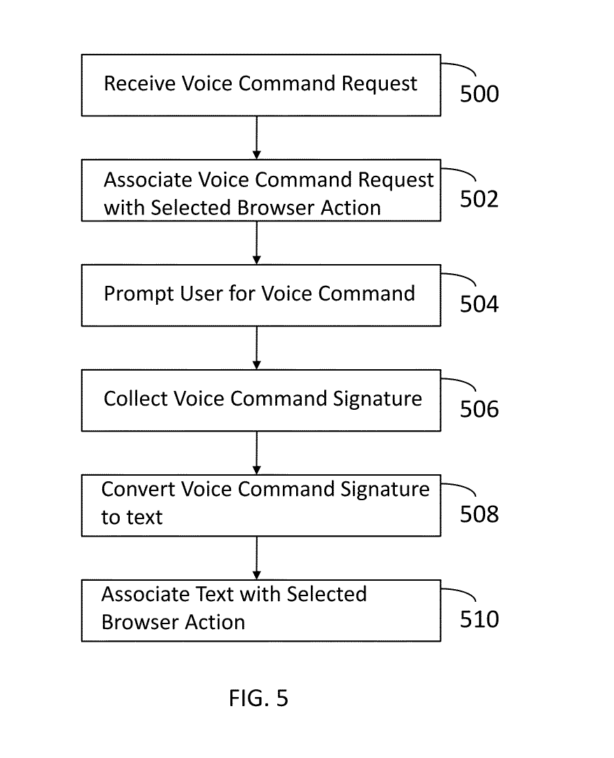

FIG. 5 illustrates operations associated with the processing of browser voice commands in accordance with an embodiment of the invention. A request is received to specify a voice command 500. In one embodiment, the voice command mode is entered by shaking the mobile device 102. This may be implemented by tracking accelerometer signals associated with the mobile device. If the accelerometer signals pass a specified threshold, then the voice command mode is invoked. Most mobile devices are equipped with acceleration sensors, which capture changes in acceleration in X, Y and Z directions. The proxy command browser 122 may be configured to read these signals and compare them to stored values indicative of shaking of a mobile device. The stored values represent signatures indicative of shaking a mobile device. For example, speed changes from small to large in a short period of time or sudden reversals of direction may invoke voice command mode. The accelerometer signals may be low-pass filtered. A low-pass filter is an electronic filter that passes low-frequency signals while attenuating signals with frequencies above a cut-off frequency.

A proximity sensor on the mobile device may also be used. In this mode, when a proximity sensor signal passes a specified threshold, for example indicative of holding the mobile device close to the body of a user, then the voice command mode is entered. Alternately, an ambient light sensor signal transitioning past a specified threshold may be used to invoke the voice command mode. For example, if a sudden transition in ambient light occurs due to a user moving a mobile phone close to his or her body, the voice command mode may be invoked. A microphone associated with the mobile device may also be used to invoke voice command mode. If the microphone receives a signal above a certain threshold, then the voice command mode may be invoked. Other techniques may be used to invoke the voice command mode, such as a menu selection or a button on the mobile device. The button may be a fixed key on the mobile device or a software controlled button. Combinations of accelerometer, proximity sensor and ambient light sensing may be used to invoke the voice command mode.

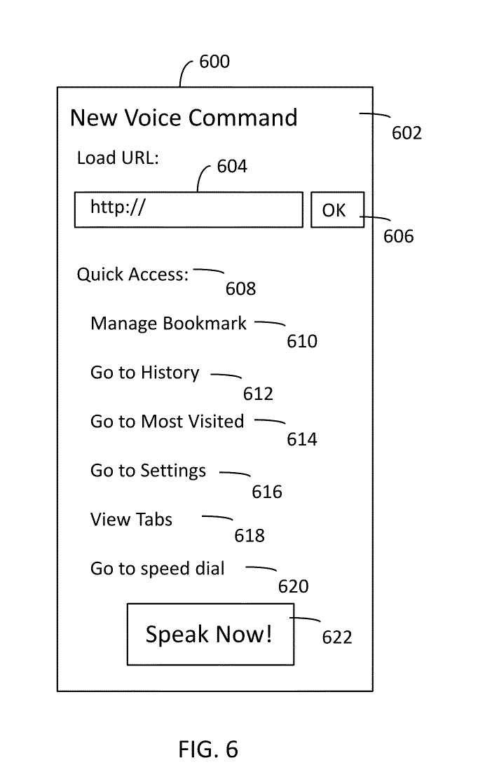

The next processing operation of FIG. 5 is to associate a voice command request with a selected browser action 502. FIG. 6 illustrates a voice command GUI 600 that may be used in accordance with an embodiment of the invention. The GUI 600 indicates the ability to define a new voice command 602. The voice command may be associated with a URL, which may be typed into block 604, the completion of which is indicated by OK key 606. Tapping on block 604 invokes a keyboard (not shown). Alternately, a voice command may be associated with quick access operations 608, such as manage bookmark 610, go to history 612, go to most visited cites 614, go to settings 616, view tabs 618 and go to speed dial 620. Once an action is specified, a command may be displayed to speak, such as block 622. The uttered voice command is then associated with the specified action. Observe in FIG. 6 that block 604 may be used to specify a user-defined voice command. The quick access options 608 effectively operate to train a pre-existing list of commands. That is, the browser 122 is configured to support a pre-existing list of commands and is further configured to receive voice commands. A specific voice command is then correlated to a specific pre-existing command. This constitutes a training operation to enable the voice feature of the proxy command browser 122.

Any number of voice commands may be specified. For example, various web page manipulation commands may be specified. Such commands may exist in a pre-populated list that waits to be matched with voice commands uttered by a user. Web page manipulation commands may include, add a bookmark, bookmark this page, go back, go forward, go to bottom of page, go to top of page, save page, refresh page, stop, zoom in, zoom out, toggle action, paste into address bar, paste and search, exit browser and add to speed dial. Tab manipulation commands may also be defined, such as open a new tab, close all tabs, close other tabs, close tab, left tab and right tab.

Quick access commands, such as shown in FIG. 6 may also be defined. Additional quick access commands may include manage add-on, go to downloads, go to bookmarks, go to add ons, go to filtered content, search and speed dial. Advanced settings may also be defined, such as toggle night mode, toggle desktop mode, desktop mode, iphone® mode, ipad® mode, Android® mode, toggle image mode, toggle full screen, change themes, toggle screen mode, toggle compress view, subscribe to rss (really simple syndication) feed, send feedback, create gesture, toggle zoom button. Data option commands may also be defined, such as backup data, restore data, toggle private mode, clear cache and clear history.

Returning to FIG. 5, the next operation is to prompt the user for a voice command 504. For example, the “speak now” block 622 of FIG. 6 may be used to implement this operation. In an alternate embodiment, the speak command is presented first. Thereafter, the uttered command is associated with an operation, e.g., one of the operations 604-620 of FIG. 6.

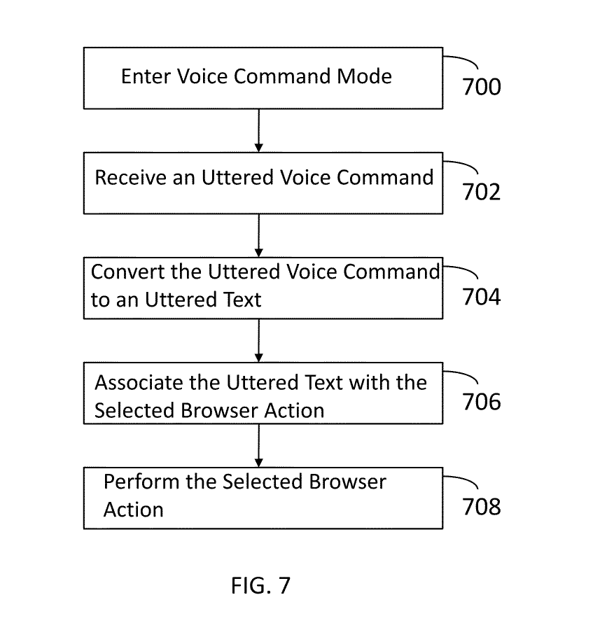

The voice command signature is collected 506. The voice command signature is converted to text 508. Any number of available speech-to-text applications may be used to implement this operation. The text is then associated with the browser action 510. Various commands of the type discussed above may be associated in advance with a sequence of browser operations. The commands are associated with a voice utterance. Thereafter, when the voice utterance is received, the specified sequence of browser operations is automatically executed, as shown in connection with FIG. 7.

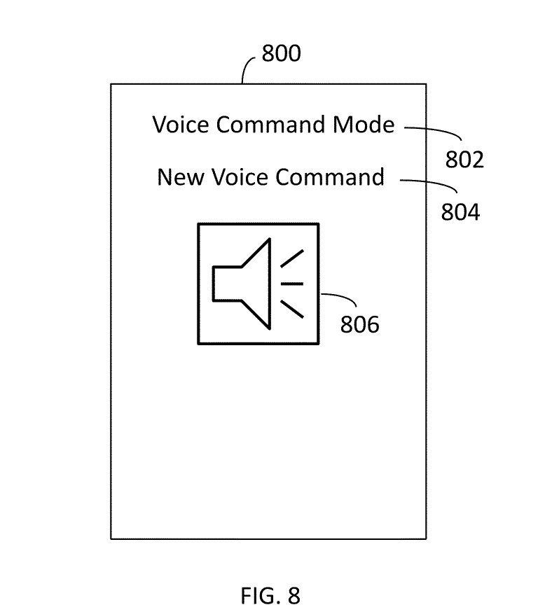

The first operation of FIG. 7 is to enter the voice command mode 700. Any of the actions discussed above may be used to enter voice command mode. GUI 800 of FIG. 8 may be displayed. GUI 800 illustrates a voice command mode 802. A new voice command 804 may also be specified, selection of which results in the GUI 600 of FIG. 6.

The next operation of FIG. 7 is to receive an uttered voice command 702. GUI 800 illustrates a speaker icon 806 indicative of a voice command mode. An uttered voice command is received in voice command mode. The uttered voice command is then converted to uttered text 704. The uttered text is associated with a selected browser action 706. The selected browser action is then performed 708.

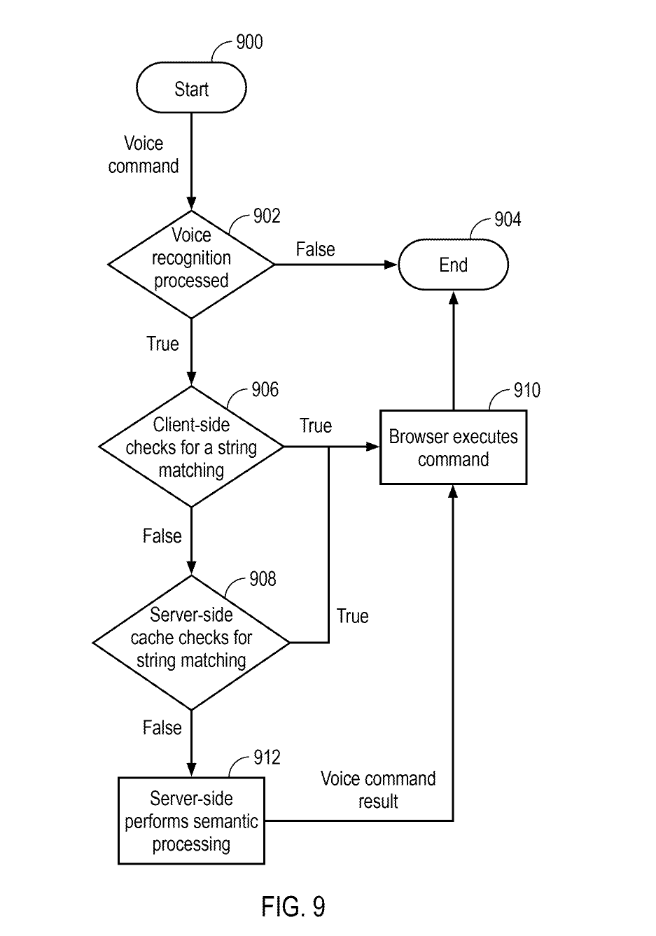

FIG. 9 illustrates voice processing operations associated with an embodiment of the invention. In particular, the figure illustrates client-side and server-side processing of a voice utterance. FIG. 9 illustrates a start operation 900 to receive a voice command. Block 902 checks for an adequate acoustical signal. If one is not received, then the process is terminated 904. If an adequate signal is received, the client device 102 checks for a string match 906. That is, the utterance is converted to uttered text. The uttered text is then compared to an existing list of text commands, which have associated browser actions. If a match is found, then the browser executes the command 910. If a match is not found, the proxy command browser 122 passes the uttered text to the browser support server module 172. The server 104 checks for a string match 908. If a match is found, the browser support server module 172 sends the browser 122 the corresponding command and the browser executes the command 910. If a string match is not found, the browser support server module 172 performs semantic processing 912.

Observe that FIG. 9 has speech recognition operations (blocks 906 and 908) and semantic identification (block 912). In the speech recognition phase, a voice utterance is converted to text. In the semantic identification phase, the system interprets the text in order to understand the command. The browser 122 may communicate with the browser support server module 172 via an application program interface (API).

Voice command recognition may be processed on both the client side and the server side, depending upon response time and bandwidth considerations. The client may act as a local cache, which has a subset of a mapping table, matching the voice command to the text. If there is a match, the voice command is executed on the client side. If there is no match, then a request is sent to the server side for real-time computing.

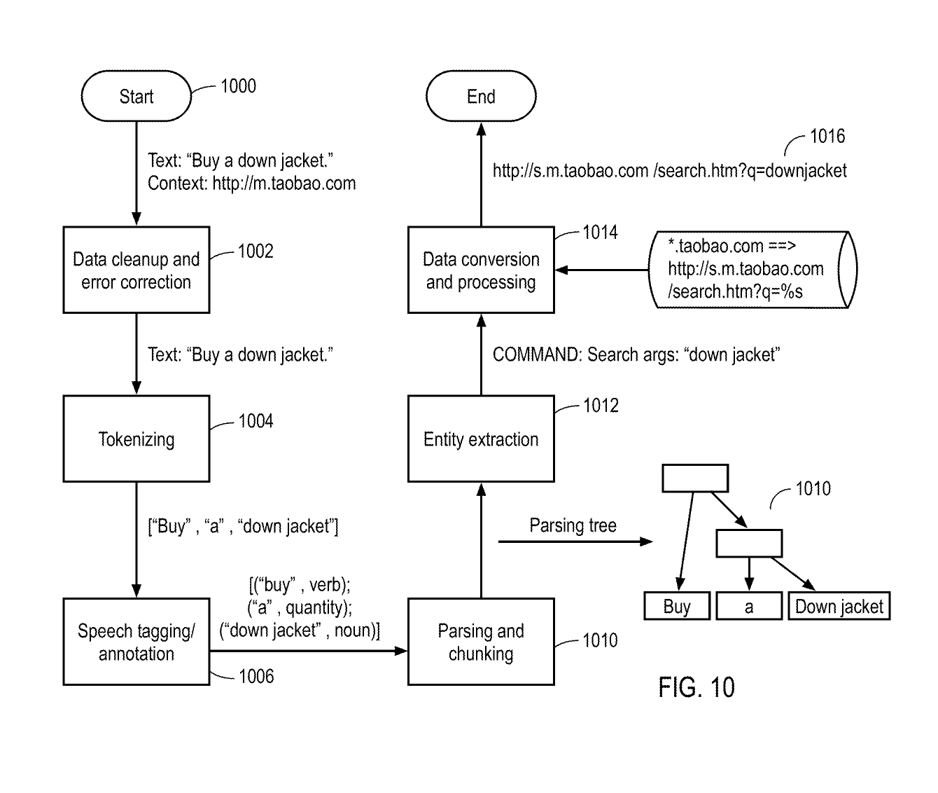

FIG. 10 illustrates server-side voice processing performed in accordance with an embodiment of the invention. The browser support server module 172 may be used to implement these operations. Block 1000 is a start operation where the browser receives an uttered voice command “Buy a down jacket.” This command is uttered in the context of being on a site “m.taobao.com”. A data cleanup and error correction operation is performed 1002. This operation is desirable because various factors (e.g., speaking voice, background noise, and other interference) preclude complete accuracy. In addition, natural speech will not always be standard. The data cleanup and error correction processing may correct the data (without damaging the original data) by removing static, identifying related words, and matching homophones (e.g., to increase matching reliability through statistical matching with fuzzy logic).

The next operation of FIG. 10 is tokenizing 1004. Identification of natural speech depends on the smallest semantic unit of language (e.g., for the English language—words; for the Chinese language—words, not characters). Different languages have different techniques for tokenization. For example, in English each word is a unit and words are separated by spaces, while in Chinese adjacent characters form words and there are no such spaces or other separators. Therefore, for English, regular tokenization is used to distinguish between words, while for Chinese, various known tokenization approaches may be used (see, e.g., http://technology.chtsai.org/mmseg/). Accuracy of tokenization may be reinforced by a segmentation algorithm and a words database. In this example, tokenizing results in the tokens “buy”, “a” and “down jacket”. Alternately, “down jacket” can be processed as two entities: “jacket” as a noun and “down” as an adjective.

The next operation of FIG. 10 is speech tagging and annotation 1006. This operation performs tagging on the parts of speech of the natural speech input text. The same word in different contexts (e.g., before and after a statement's text) may have different meanings and parts of speech (verbs, nouns, etc. . . . ). Part of the speech tagging process may involve collection of statistics (a corpus) and machine learning. For the corpus, the browser collects test data from users and uses machine learning to improving its tagging of speech parts. In one embodiment, this approach utilizes the N-gram method (http://en.wikipedia.org/wiki/N-gram) of chained tagging. In this example the following tags result: (“buy”, verb), (“a”, quantity) and (“down jacket”, noun).

Parsing and chunking of the tagged words is then performed 1008. Operations 1002-1006 involve fine-grained information processing (looking at each part of the sentence and tagging figures of speech). Now the sentence is processed as a whole to remove ambiguity and otherwise discern user intent. Natural speech processing focuses on language structure and groups levels of analysis—that is, the syntactic level of natural speech—in order to analyze ambiguity. An Earley Parser approach may be used (e.g., http://en.wikipedia.org/wiki/Earley_parser). Different sets of rules may be defined and adjusted (context free grammar) for different languages. The final result is a syntactic parse tree 1010.

Entity extraction is then performed 1012. In particular, entities of the voice command are extracted. Entity extraction is carried out in the order of a specified priority. Once a successful result is returned, the program extracts the argument with its corresponding action, moving on to the next entity in the chain. If an entity is unable to be extracted in the end, the program may search a database for the voice command entity. In this example, the argument “down jacket” is identified.

The final operation of FIG. 10 is data conversion and processing 1014. At this point, the entities that have been extracted are still in an abstract state (e.g., “sina homepage”). Only after a certain amount of conversion can the entity be directly processed into browser-identifiable items (e.g., “http://www.sina.com.cn”). One may employ a database with website addresses and arguments. In one embodiment, entities are matched with arguments in the database. The arguments are then associated with a web address. In this example, a context of “http://m.taobao.com” was received. This is associated with the URL http://s.m.taobao.com. The argument “downjacket” is then passed to this web site, as shown with command 1016.

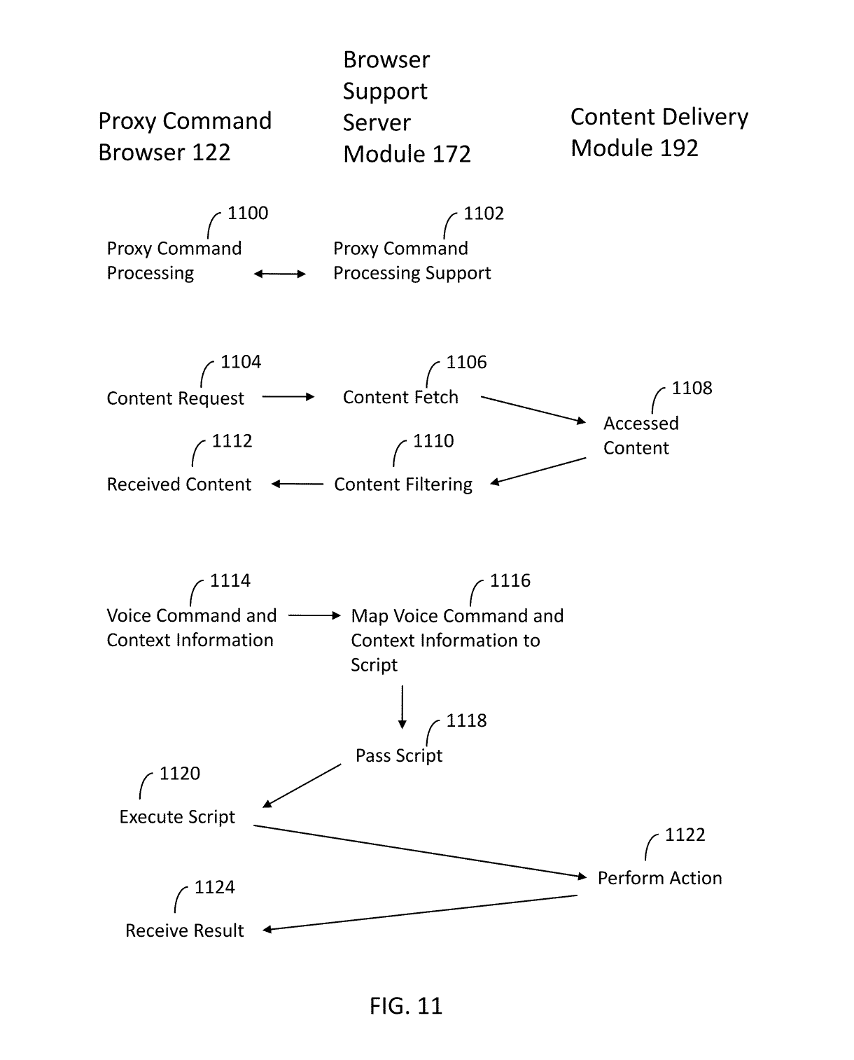

FIG. 11 illustrates various processing modes for the proxy command browser 122. In particular, the figure illustrates the proxy command browser 122 interacting with the browser support server module 172 and the content delivery module 192. In one operative mode, proxy command processing 1100 is performed by the proxy command browser 122 on client device 102 with proxy command processing support 1102 from the browser support server module 172 of server 104. The processed commands may be voice commands and/or physical gestures applied to the mobile device.

In another operative mode, the proxy command browser 122 communicates with the browser support server module 172 to control a content feed. For example, a content request is issued 1104 and content is fetched 1106. That is, the browser support server module 172 communicates with the content delivery module 192 to access content 1108. The content is then filtered 1110. The filtered content is then received 1112 by the proxy command browser 122. Observe here that the browser support server module 172 is operative as an intermediary between the content delivery module 192 of a content server 106 and the proxy command browser 122 of a client 102. In one embodiment, the browser support server module 172 tracks the user's content requests and notes user preferences. These preferences may also be obtained from a user filling out a preference form. The preference information is used to filter optimal content for a given user. For example, a user may prefer national news over international news and content is filtered accordingly. Alternately, a user may prefer basketball information over any other type of sports information and content is filtered accordingly. This feature of the invention is sometimes referred to as “Webzine”, which is discussed further below.

The content filtering performed by the browser support server module 172 may be performed in accordance with user preferences, as discussed above. Alternately, or in addition, the content filtering may be performed for optimized layout on a mobile device. In one embodiment, the browser support server module 172 analyzes a web site or content server at a structural level. For example, the browser support server module 172 may employ a set of rules to determine significant content based upon such features as the position of the content on a page, the size of the font for a headline (if any) associated with the content, or whether the content has an associated picture. The browser support server module 172 may also evaluate a web site for key words that strongly correlate with user preferences or past user browsing activity. This analysis may be performed in real-time in response to a request. The real-time analysis may be assisted by offline analyses of web sites.

FIG. 11 illustrates an additional mode of processing associated with an embodiment of the invention. In particular, the browser support server module 172 may operate to retrieve information in response to a voice command. More particularly, the browser support server module 172 may facilitate operations within a navigated web site. For example, the proxy command browser 122 may pass voice command and context information 1114 to the browser support server module 172. The voice command and context information is then mapped to a script 1116. FIG. 10 illustrates an example of a voice command “Buy a down jacket” and context http://m.taobao.com are passed to a browser support server module 172. This resulted in command 1016, which invoked the relevant web cite and passed a parameter (i.e., “downjacket”) to the web cite. In this embodiment, the voice command and context information are associated with a script to perform a set of operations. The script is passed 1118 by the browser support server module 172 to the proxy command browser 122. The script is then executed 1120.

The script may specify a sequence of operations to implement the voice command in the given context. As a result, an action is performed 1122 by a content delivery module 192. This produces a result, which is received 1124 by the proxy command browser.

Consider a case where the browser is on a given web page and the voice command mode is invoked. A voice instruction to “share” results in a voice command of “share” and the context is the given web page. The share command may be associated with a social network service. A relevant script is then invoked. The script specifies operations that cause the given web page to be automatically shared to the user's account at the social network service. For example, an utterance such as “share to Twitter®” or “Tweet this” results in the browsed content being shared to the user's Twitter® account. Similarly, an utterance such as “like this” or “post this” may result in browsed content being posted to a user's Facebook® account. Thus, certain utterances may be associated with certain social network services. Scripts are formed to implement commands for the given context. The script is passed to the proxy command browser 122 for execution.

The foregoing example is an instance of a single proxy instruction causing web content currently being viewed by a user to be shared on a social network service. The single proxy instruction was a voice command. The proxy command browser 122 may also include support for a single proxy gesture to implement this share operation. The invoked social network service may be a default service specified by the user. Alternately, the invoked social network service may be the last social network service visited by a user. Alternately, the proxy command browser 122 may evaluate the content of the web site, for example by looking for certain key words, and automatically select a presumed most relevant social network service.

The voice commands may also be used to connect to commonly accessed web sites. For example, URLs for commonly accessed web sites, such as Facebook®, Google® and ESPN® may be pre-populated in the browser. A voice utterance is subsequently associated with the URL. For example, the quick access commands 608 of FIG. 6 may be substituted with commonly accessed web sites. The user is then prompted to provide a voice command associated with a given web site. In one embodiment, a user is prompted to provide various utterances for the same web site. Thus, the disclosed browser supports multiple utterances for a single web site or command.

In the case of an information resource, such as Google®, Bing® or Wikipedia®, the user may utter the name of the site, plus a search term. The name of the site operates as a function call to the site and the search term operates as a passed parameter to the site. The search site utterance is converted to text to invoke the search site and the search term is converted to text and is passed to the search site as a search term. Similarly, in the case of a shopping resource, such as ebay® or Amazon®, the user may utter the name of the site, plus a search term. Social network sites may be utilized in a similar manner. For example, an utterance of the name of such a site plus a name of an individual to be found on the site may result in the specified site being opened and the individual searched on the site. For example, one may utter “linkedin Mary”, which results in a call to www.linkedin.com and a search for “mart'” on the user's account. A command with multiple parameters may also be processed in accordance with an embodiment.

Similar approaches may be used for such actions as “watch video”, “play music” and “read news”. In this case, the user may have trained the browser to associate the command “watch video” with www.youtube.com, the command “play music” with www.pandora.com and the command “read news” with www.cnn.com.

Alternately, the user may train the browser to associate a command with a set of resources. For example, a command “play music” may result in the delivery of a page from the browser support server module 172, which lists a set of music resources that may be invoked. In this way, multiple resources from multiple web sites may be integrated and become accessible through a single voice command.

The browser 122 may be configured to advise the browser support server module 172 of poor voice command performance. For example, an “add feedback” button may be provided on the browser. The selection of this button may push an email to the browser support server module 172, where the email includes a recording of the unrecognized utterance. The email may or may not be associated with a textual description of the meaning of the utterance, as supplied by the user.

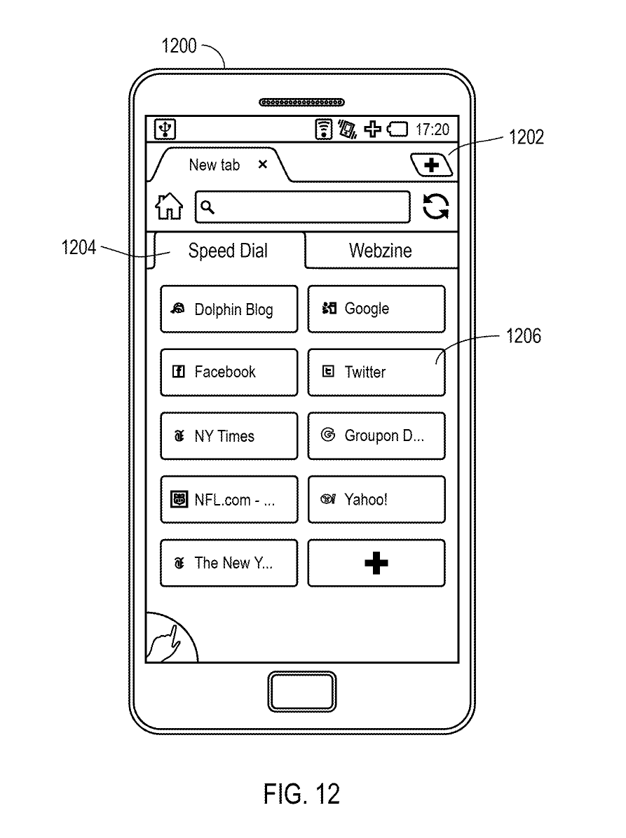

FIG. 12 illustrates a mobile device 1200 executing a proxy command browser 122 with a GUI 1202. This GUI features a “speed dial” 1204 or listing of frequently accessed web sites 1206.

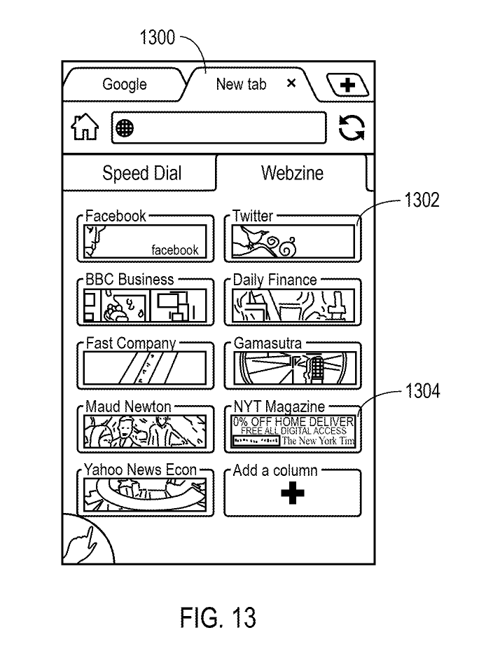

FIG. 13 illustrates a GUI 1300 associated with a proxy command browser 122. This GUI provides a list of information resources, such as 1302 and 1304, that are available as filtered content through the browser support server module 172, as discussed in connection with operations 1104-1112 of FIG. 11.

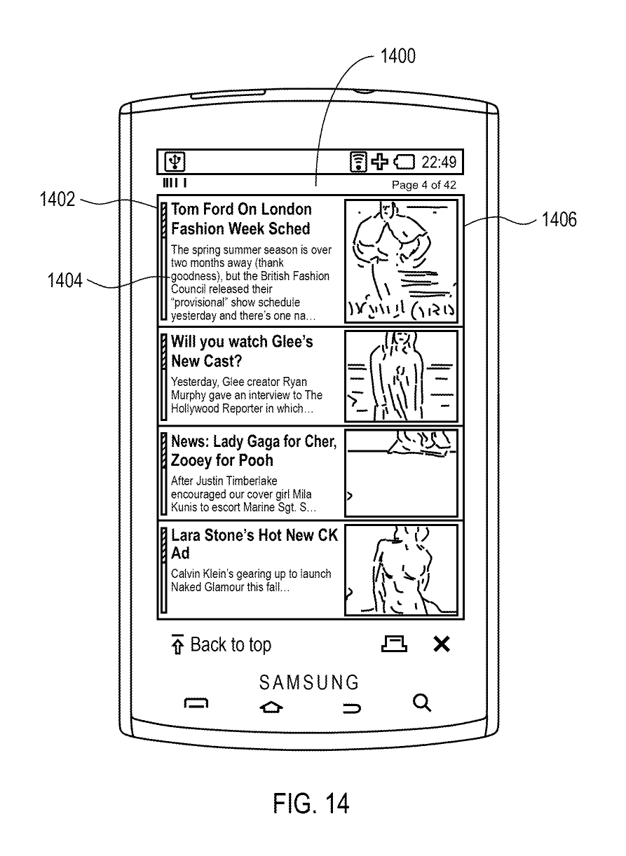

FIG. 14 illustrates a GUI 1400 that has received such filtered content from a browser support server module 172. In this example, the filtered content includes a number of stories, where each story includes a title 1402, a snippet of text 1404 and an image 1406.

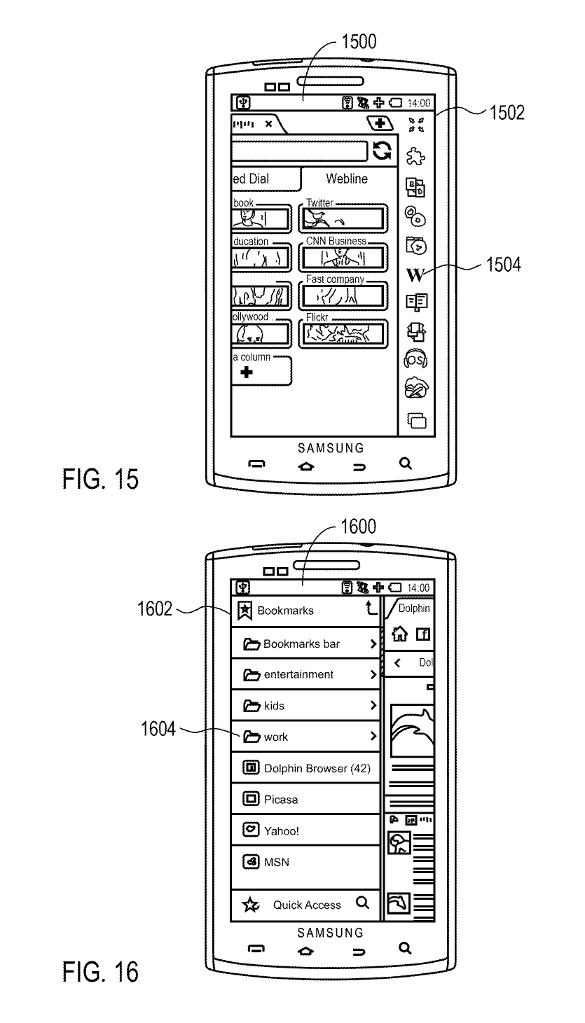

FIG. 15 illustrates a GUI 1500 with a normally hidden side bar 1502. The side bar 1502 is accessed through a proxy command, such as a gesture to slide the GUI to the left or a voice command to move the GUI to the left. This results in the display of a set of tools 1504 that may be used in connection with the browser. These tools may include web page manipulation tools, tab manipulation tools, quick access tools and the like.

FIG. 16 illustrates a GUI 1600 with a normally hidden side bar 1602. The side bar 1602 is accessed through a proxy command, such as a gesture to slide the GUI to the right or a voice command to move the GUI to the right. This results in the display of a bookmark list 1604 that may be used in connection with the browser. The bookmark list may specify bookmarked web sites and/or operations associated with management of bookmarks.

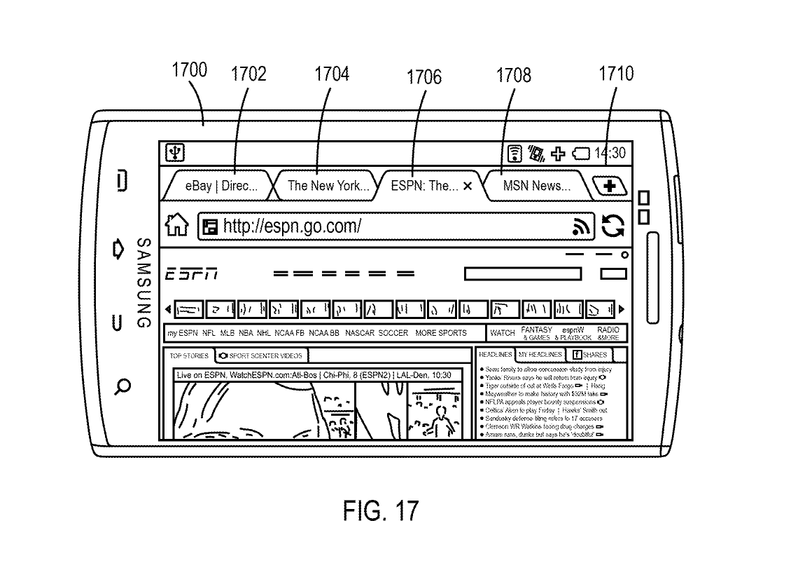

FIG. 17 illustrates a GUI 1700 with a set of tabs 1702, 1704, 1706 and 1708. In an embodiment, the proxy command browser 122 supports multiple browsing sessions, where each browsing session is represented with a tab. A new tabbed session may be opened by selecting icon 1710.

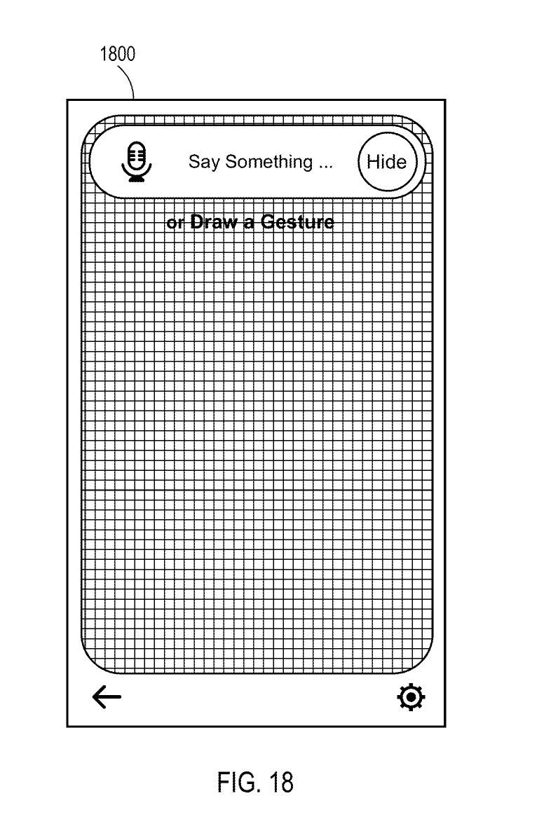

FIG. 18 illustrates a unified voice command and gesture GUI 1800 that may be used in accordance with an embodiment of the invention. The GUI 1800 invites a user to “Say something . . . ” or “Draw a Gesture”. Thus, in this mode, the user may enter either type of proxy command.

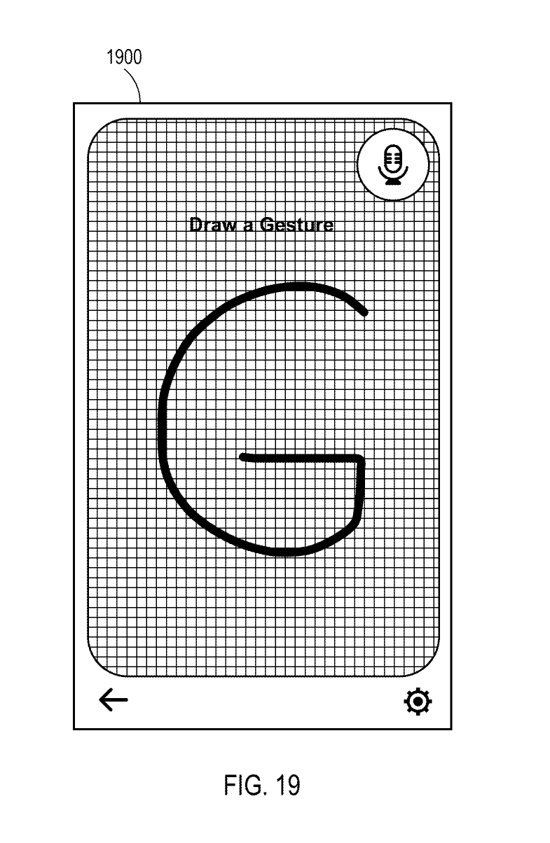

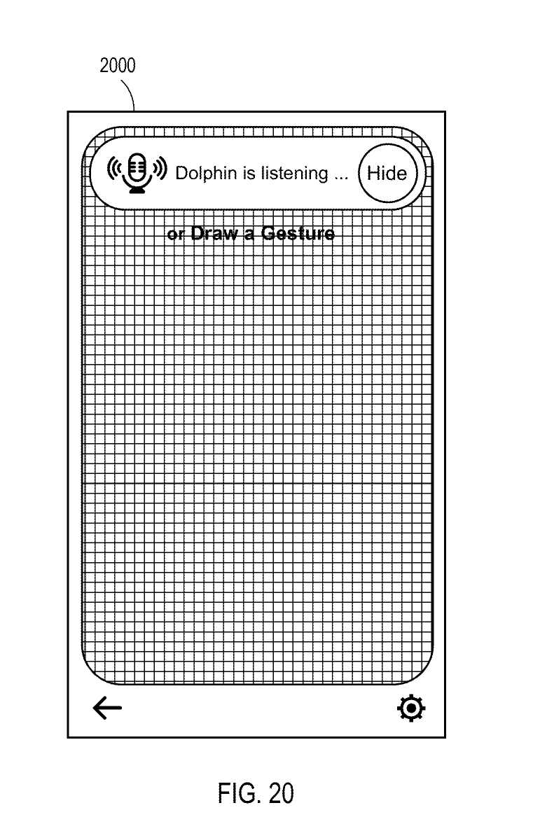

FIG. 19 illustrates a gesture “G” entered into the GUI 1900. FIG. 20 illustrates a GUI 2000 in a listening mode. The GUI 2000 may include text indicating that a command is being processed, that a command is not understood and/or an invitation to speak again.

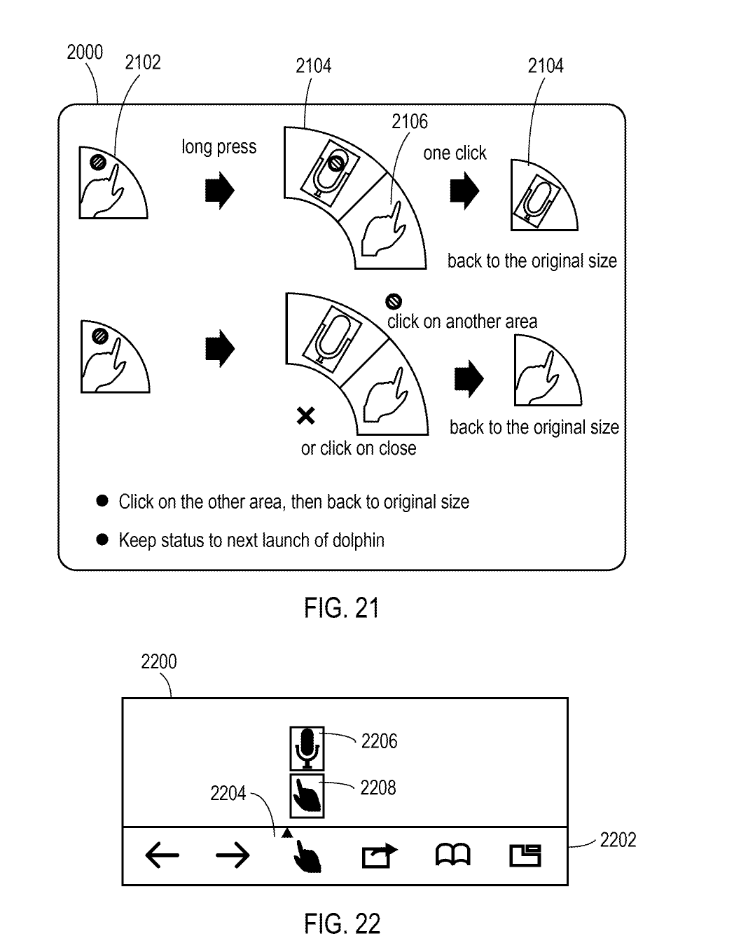

The listening mode may have been invoked by any of the techniques discussed above or by one of the techniques displayed in FIGS. 21 and 22. FIG. 21 illustrates a GUI 2100 with a proxy command icon 2102, which when pressed, provides a voice icon 2104 and a gesture icon 2106. In this example, the user selects voice icon 2104, which invokes the voice command mode. FIG. 22 illustrates a GUI 2200 with a command bar 2202, which includes a proxy command icon 2204. Pressing the proxy command icon 2204 provides a voice command icon 2206 and a gesture command icon 2208.

Voice command processing is preferably shut down if an utterance is not received in some specified time period (e.g., 8 seconds). Alternately, the voice command mode may be maintained for a longer period of time if the mobile device is charging.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium storing instructions defining a mobile device browser, wherein the mobile device browser supports direct command inputs, the improvement comprising executable instructions to:
correlate a proxy command to a selected direct command input, wherein the proxy command is alternately expressed as a gesture and a voice command; and
execute the selected direct command input.

2. The computer readable storage medium of claim 1 wherein the voice command is processed by a mobile device executing the mobile device browser.

3. The computer readable storage medium of claim 2 wherein the mobile device browser interacts with a browser support server to process the voice command.

4. The computer readable storage medium of claim 3 wherein the mobile device browser passes the voice command and context information to the browser support server.

5. The computer readable storage medium of claim 4 wherein the mobile device browser receives a script from the browser support server, wherein the script is executed by the mobile device browser to request an action corresponding to the voice command and context information.

6. The computer readable storage medium of claim 5 wherein the action is a specified interaction with one of a web site, a web service and a web application.

7. The computer readable storage medium of claim 6 wherein the specified interaction includes a function call and a passed parameter.

8. The computer readable storage medium of claim 7 wherein the function call is to a specified web site and the passed parameter is used as a search term at the specified web site.

9. The computer readable storage medium of claim 1 wherein the gesture is a pre-existing gesture.

10. The computer readable storage medium of claim 1 wherein the gesture is a user-defined gesture.

11. The computer readable storage medium of claim 1 wherein the mobile device browser includes executable instructions to display a list of frequently accessed web sites.

12. The computer readable storage medium of claim 1 wherein the mobile device browser includes executable instructions to display filtered content from a browser support server.

13. The computer readable storage medium of claim 12 wherein the filtered content includes a plurality of stories, wherein each story of the plurality of stories includes a title, a snippet of text and an image.

14. The computer readable storage medium of claim 1 wherein the mobile device browser includes executable instructions to provide a first sidebar accessible through a first proxy command.

15. The computer readable storage medium of claim 14 wherein the first sidebar provides tool resources.

16. The computer readable storage medium of claim 1 wherein the mobile device browser includes executable instructions to provide a second sidebar accessible through a second proxy command.

17. The computer readable storage medium of claim 16 wherein the second sidebar provides a bookmark list.

18. The computer readable storage medium of claim 1 wherein the mobile device browser includes executable instructions to simultaneously support multiple browsing sessions, wherein each browsing session is represented with a tab.

19. The computer readable storage medium of claim 1 wherein the mobile device browser includes executable instructions to process a single proxy instruction and cause web content currently being viewed by a user to be shared on a social network service.

20. The computer readable storage medium of claim 1 wherein the mobile device browser includes executable instructions to enter a voice command mode in response to a received accelerometer signal passing a specified threshold.

21. The computer readable storage medium of claim 1 wherein the mobile device browser includes executable instructions to enter a voice command mode in response to a received proximity sensor signal passing a specified threshold.

22. The computer readable storage medium of claim 1 wherein the mobile device browser includes executable instructions to enter a voice command mode in response to a received ambient light sensor signal passing a specified threshold.

23. The computer readable storage medium of claim 1 wherein the mobile device browser includes executable instructions to enter a voice command mode in response to a received microphone signal passing a specified threshold.

24. The computer readable storage medium of claim 1 wherein the mobile device browser includes executable instructions to enter a voice command mode in response to the processing of an accelerometer signal, a proximity sensor signal and an ambient light sensor signal.

25. The computer readable storage medium of claim 1 wherein the mobile device browser includes executable instructions to present a unified gesture and voice command graphical user interface.
